(19) United States
(12) Patent Application Publication
(10) Pub. No.: US 2023/0214710 A1
(43) Pub. Date: Jul. 6, 2023

(54) AUTOMATED QUERY BASED CHATBOT PROGRAMMING

(71) Applicant: International Business Machines Corporation, Armonk, NY (US)

(72) Inventors: Sarbajit K. Rakshit, Kolkata (IN); Craig M. Trim, Ventura, CA (US); James E. Bostick, Cedar Park, TX (US); John M. Ganci, JR., Raleigh, NC (US); Martin G. Keen, Cary, NC (US)

(73) Assignee: International Business Machines Corporation, Armonk, NY (US)

(21) Appl. No.: 17/569,621

(22) Filed: Jan. 6, 2022

(51) Int. Cl. G06N 20/00; G06F 16/242

(52) U.S. Cl. CPC G06N 20/00; G06F 16/243

(57) ABSTRACT

At a first chatbot, a query expressed in natural language form is received. It is determined that responding to the query requires data external to the first chatbot. From a data source external to the first chatbot, response data corresponding to the query is obtained. Using the response data, the query is responded to in natural language form. Using the response data, the first chatbot is updated.

### BACKGROUND

The present invention relates generally to a method, system, and computer program product for chatbot programming. More particularly, the present invention relates to a method, system, and computer program product for automated query based chatbot programming.

A chatbot is software that uses a set of rules, machine learning, and natural language processing techniques to understand queries expressed in natural language and respond in natural language, simulating human conversation. A query, or utterance, is an input to the chatbot, and an answer or response is an output from the chatbot. An intent is an utterance's intention. For example, for an utterance of “tell me tomorrow's weather”, an intent might be a function called getWeather( ). An entity is a word or set of words that consistently refers to the same thing, and modifies an intent. For example, for an utterance of “tell me tomorrow's weather”, one entity might be the calendar date corresponding to tomorrow.

Utterances and responses are expressed using text, audio, or another input method or combination of methods. Some chatbots are implemented as individual modules with their own user interface. For example, a chatbot might be implemented within a website to answer text-based customer service questions. Other chatbots are implemented as modules sharing a common user interface, in which the interface receives a query, selects a chatbot best suited to answer the query, and routes the query to the selected chatbot for further interaction. For example, a user interface that interacts orally with a user might receive a query about the current weather, select a chatbot configured to answer weather-related queries, and route the current weather query to the weather chatbot for further interaction. A chatbot typically includes two components: a compendium of data on a particular topic (also called a knowledge base) and a generic user interface that interprets queries and formulates answers using data in the knowledge base. Each component is typically developed separately, allowing reuse of the generic user interface with different knowledge bases and allowing a new chatbot to be implemented by pairing a new knowledge base with an existing user interface.

In some chatbots, the knowledge base includes one or more template answers corresponding to an intent. For example, in a knowledge base for a chatbot configured to answer weather-related queries, a template answer to the getWeather( ) intent might be “[tomorrowDate]'s weather will be [weatherCondition], with a high of [highTemp] and a low of [lowTemp]”, where [tomorrowDate], [weatherCondition], [highTemp], and [lowTemp] are placeholders to be filled in with appropriate data when the chatbot formulates an answer to a particular query.

Template answers are often formulated only for intents considered most likely to occur, and thus an intent may not have a template answer. In such a case, some chatbots query a corpus of data and use a natural language processing technique to formulate an answer with data from the corpus. For example, in a knowledge base for a chatbot configured to answer weather-related queries, there may be no template answer for a query about a forecast for an upcoming hurricane season. However, the chatbot may have access to a data corpus including the requested forecast. Thus, the chatbot use a natural language processing technique to convert data in the requested forecast to a natural language answer for a user.

In some environments, a chatbot is configurable to supplement its knowledge base with a response provided by another, associated chatbot. In particular, if Chatbot A is unable to answer a query from its own knowledge base or a corpus of data to which the chatbot has access, Chatbot A determines that Chatbot B is available to answer queries from Chatbot A, and queries Chatbot B. If able, Chatbot B provides a response to Chatbot A, and Chatbot A relays the response to a user. In some implementations, Chatbot A credits Chatbot B as the source of the response (e.g., “Chatbot B has provided the following . . . ”). For example, suppose a chatbot configured for customer service for a car rental company receives a query regarding the maximum weight a particular model of rental car can tow. The car rental chatbot determines that its own knowledge base does not include the required data, but that another chatbot, operated by the manufacturer of that model of rental car, is accessible and able to answer the query. The manufacturer's chatbot provides an answer (e.g., “That model can tow a vehicle with a maximum weight of 3000 pounds.”) to the car rental chatbot, and the car rental chatbot relays the answer to the user (e.g., “I've asked that model's manufacturer, which says that model can tow a vehicle with a maximum weight of 3000 pounds.”).

### SUMMARY

The illustrative embodiments provide a method, system, and computer program product. An embodiment includes a method that receives, at a first chatbot, a query, the query expressed in natural language form. An embodiment determines that responding to the query requires data external to the first chatbot. An embodiment obtains, from a data source external to the first chatbot, response data corresponding to the query. An embodiment responds, using the response data, to the query, the responding resulting in a response expressed in natural language form. An embodiment updates, using the response data, the first chatbot.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for automated query based chatbot programming in accordance with an illustrative embodiment;

FIG. 4 depicts an example of automated query based chatbot programming in accordance with an illustrative embodiment;

FIG. 5 depicts a continued example of automated query based chatbot programming in accordance with an illustrative embodiment;

FIG. 6 depicts a continued example of automated query based chatbot programming in accordance with an illustrative embodiment;

FIG. 7 depicts a continued example of automated query based chatbot programming in accordance with an illustrative embodiment;

FIG. 8 depicts a flowchart of an example process for automated query based chatbot programming in accordance with an illustrative embodiment;

FIG. 9 depicts a cloud computing environment according to an embodiment of the present invention; and

FIG. 10 depicts abstraction model layers according to an embodiment of the present invention.

### DETAILED DESCRIPTION

The illustrative embodiments recognize that chatbots typically operate independently. Thus, if a chatbot does not have data with which to answer a query, the chat has no means to obtain data from another chatbot or data source.

The illustrative embodiments also recognize that a new chatbot, or new data for an existing chatbot, is typically implemented by determining a need for a chatbot to provide information on a particular topic, creating a knowledge base with data on the topic, and pairing the new knowledge base with an existing user interface. Human analysts typically determine the need and gather data for the knowledge base. However, without a systematic analysis of existing subject matter coverage, the need determination and the resulting knowledge base are unlikely to meet users' actual needs. Humans rarely perform a sufficiently systematic analysis. Instead, the chatbot implementation decision is often ad hoc, based on a manager's perception of what is needed or user complaints reaching a threshold level. In addition, data for the knowledge base needs to be assembled, and intents and template answers programmed or trained, even if the data already exists in another form. Thus, the illustrative embodiments recognize that there is an unmet need to automatically analyze the subject matter coverage of existing chatbots, recognize what is needed to fill a gap in the coverage, and assemble a knowledge base matching the gap efficiently.

The illustrative embodiments recognize that the presently available tools or solutions do not address these needs or provide adequate solutions for these needs. The illustrative embodiments used to describe the invention generally address and solve the above-described problems and other problems related to automated query based chatbot programming.

An embodiment can be implemented as a software application. The application implementing an embodiment can be configured as a modification of an existing chatbot system, as a separate application that operates in conjunction with an existing chatbot system, a standalone application, or some combination thereof.

Particularly, some illustrative embodiments provide a method that receives a query at a first chatbot, determines that a response to the query requires data external to the first chatbot, obtains response data corresponding to the query from a data source external to the first chatbot, uses the response data to respond to the query, and uses the response data to update the first chatbot.

An embodiment analyzes data in a knowledge base of an existing chatbot, deriving a set of topics or intents for which the chatbot is capable of answering queries as well as a set of entities, and relationships between entities, used in answering the queries. One embodiment analyzes intents and template answers of the chatbot. Another embodiment analyzes structured data, for example data structured according to a database or extensible markup language (XML) schema. Another embodiment analyzes unstructured data in natural language form, for example one or more documents expressed in a human language such as English. For example, in a chatbot configured for customer service for a car rental company, the set of topics might include making, adjusting, and cancelling car reservations for customers. The set of entities might include types of cars, locations at which cars can be picked up and returned, and names of days of the week and months of the year. Relationships between entities might include size relationships among types of cars (e.g. that a midsize car is larger than a compact car), and time relationships among days of the week (e.g. that Friday, Saturday, and Sunday are weekend days or that Monday comes after Sunday). Techniques are presently available within the field of natural language processing to analyze data in a knowledge base and derive intents, entities, template answers, and relationships.

An embodiment analyzes data of one or more queries processed by an existing chatbot. Data of a query includes the query itself as well data the chatbot extracted from the query or an interaction including the query, such as an intent of the query and any entities referenced by the query. Data of a query includes whether or not the chatbot was able to answer a query, as determined by the chatbot itself or by evaluating user satisfaction with the chatbot's response to the query. Data of a query also includes a source of the query answer, if the chatbot was able to answer a query. Some non-limiting examples of query answer sources are the chatbot's own knowledge base (including template answers and other data), a corpus of data external to the knowledge base to which the chatbot has access, and another chatbot external to the first chatbot. In one embodiment, data of a query also includes a sentiment or emotional tone of an interaction. Sentiment (e.g. positive, negative, or neutral) refers to a feeling expressed towards specific target phrases or of an interaction as a whole. Emotional tone refers to an emotion (e.g., joy, anger, sadness, or fear) conveyed by specific target phrases or by an interaction as a whole. Techniques are presently available to perform sentiment and emotional tone analysis on natural language documents. One embodiment analyzes data of one or more queries concurrently with query processing by a chatbot. Another embodiment analyzes data of one or more queries after a chatbot has completed an interaction with a user.

An embodiment uses the sets of intents, entities and relationships between entities, and query data (including a query answer source) to generate a new chatbot or update an existing chatbot. One embodiment adds a second chatbot's answers to a query to the first chatbot's knowledge base. Another embodiment adds a second chatbot's answers to the first chatbot's knowledge base only once the second chatbot has provided answers to the same query, a sufficiently similar query, or a query with a sufficiently similar topic, more than a threshold number of times. Queries that are sufficiently similar to each other are queries that have above a threshold amount of similarity to each other, as measured by a presently available similarity measurement technique. Queries with a sufficiently similar topic are queries whose topics match above a threshold amount, as measured by a presently available similarity measurement technique.

Another embodiment, using a query (or a variant form of the query) and one or more of a second chatbot's answers to the query as training data, trains the first chatbot to answer the query. Another embodiment performs the training only once the second chatbot has provided answers to the same query, a sufficiently similar query, or a query with a sufficiently similar topic, more than a threshold number of times. Techniques are presently available to train a chatbot using a set of natural language queries and responses to queries. Updating the first chatbot eliminates the overhead of relaying the query to the second chatbot and enables the first chatbot to answer the query if the second chatbot is unavailable.

The manner of automated query based chatbot programming described herein is unavailable in the presently available methods in the technological field of endeavor pertaining to chatbot implementation. A method of an embodiment described herein, when implemented to execute on a device or data processing system, comprises substantial advancement of the functionality of that device or data processing system in receiving a query at a first chatbot, determining that a response to the query requires data external to the first chatbot, obtaining response data corresponding to the query from a data source external to the first chatbot, using the response data to respond to the query, and using the response data to update the first chatbot.

The illustrative embodiments are described with respect to certain types of chatbots, knowledge bases, interactions, queries, topics, answers, answer sources, thresholds, responses, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

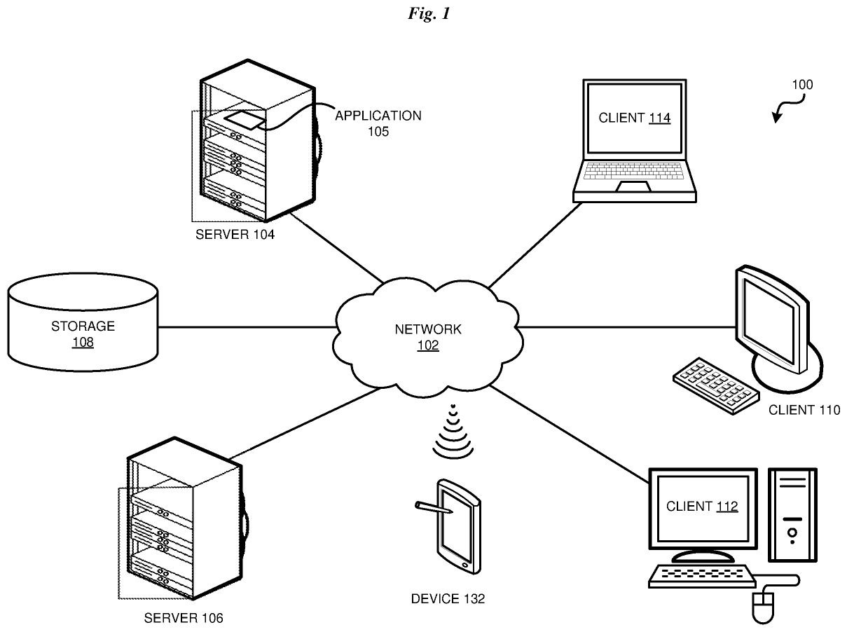

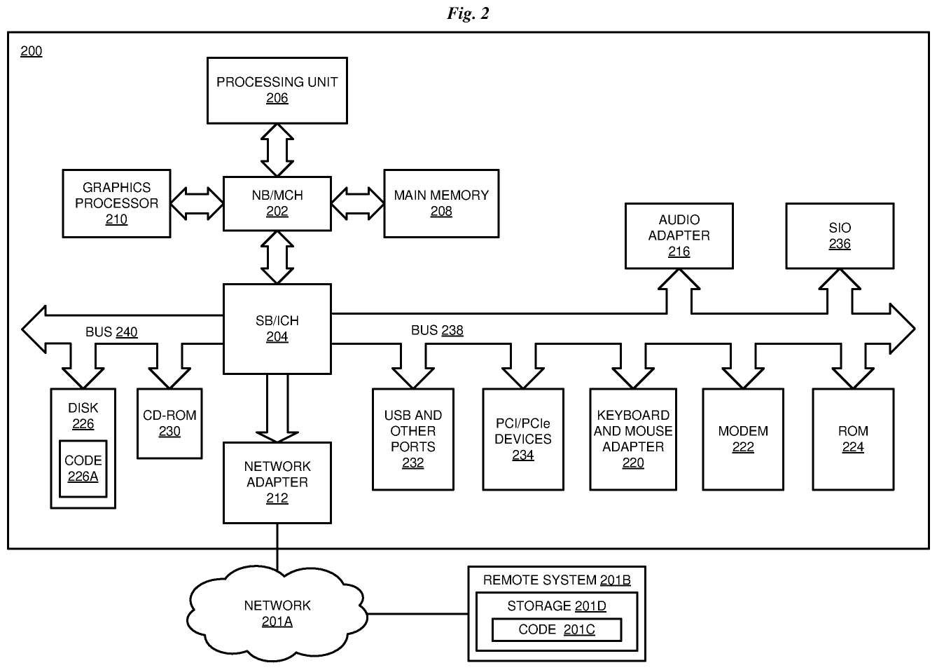

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 executes in any of servers 104 and 106, clients 110, 112, and 114, and device 132.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium. An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

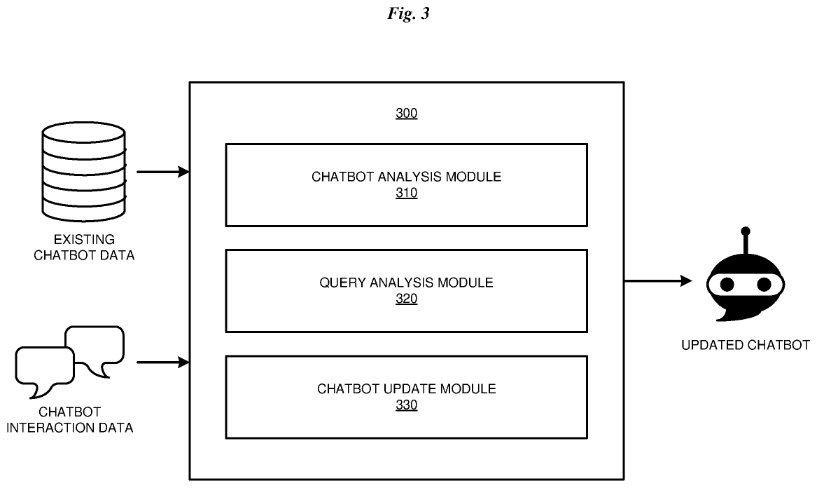

With reference to FIG. 3, this figure depicts a block diagram of an example configuration for automated query based chatbot programming in accordance with an illustrative embodiment. Application 300 is an example of application 105 in FIG. 1 and executes in any of servers 104 and 106, clients 110, 112, and 114, and device 132 in FIG. 1.

Chatbot analysis module 310 analyzes data in a knowledge base of an existing chatbot, deriving a set of topics or intents for which the chatbot is capable of answering queries as well as a set of entities, and relationships between entities, used in answering the queries. One implementation of module 310 analyzes intents and template answers of the chatbot. Another implementation of module 310 analyzes structured data, for example data structured according to a database or XML schema. Another implementation of module 310 analyzes unstructured data in natural language form, for example one or more documents expressed in a human language such as English.

Query analysis module 320 analyzes data of one or more queries processed by an existing chatbot. Data of a query includes the query itself as well data the chatbot extracted from the query or an interaction including the query, such as an intent of the query and any entities referenced by the query. Data of a query includes whether or not the chatbot was able to answer a query, as determined by the chatbot itself or by evaluating user satisfaction with the chatbot's response to the query. Data of a query also includes a source of the query answer, if the chatbot was able to answer a query. One implementation of module 320 analyzes data of one or more queries concurrently with query processing by a chatbot. Another implementation of module 320 analyzes data of one or more queries after a chatbot has completed an interaction with a user.

Chatbot update module 330 uses the sets of intents, entities and relationships between entities, and query data (including a query answer source) to generate a new chatbot or update an existing chatbot. One implementation of module 330 adds a second chatbot's answers to a query to the first chatbot's knowledge base. Another implementation of module 330 adds a second chatbot's answers to the first chatbot's knowledge base only once the second chatbot has provided answers to the same query, a sufficiently similar query, or a query with a sufficiently similar topic, more than a threshold number of times. Another implementation of module 330, using a query (or a variant form of the query) and one or more of a second chatbot's answers to the query as training data, trains the first chatbot to answer the query. Another implementation of module 330 performs the training only once the second chatbot has provided answers to the same query, a sufficiently similar query, or a query with a sufficiently similar topic, more than a threshold number of times.

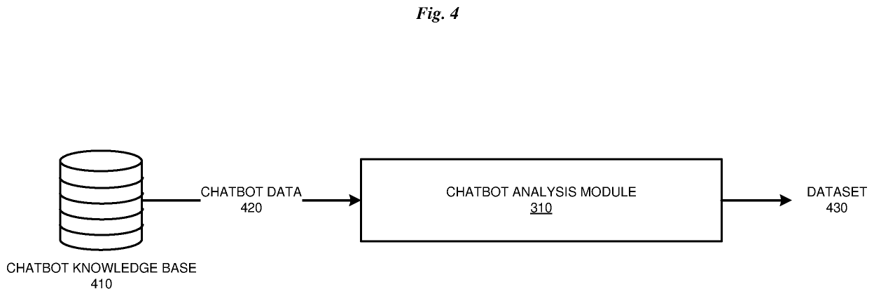

With reference to FIG. 4, this figure depicts an example of automated query based chatbot programming in accordance with an illustrative embodiment. The example can be executed using application 300 in FIG. 3. Chatbot analysis module 310 is the same as chatbot analysis module 310 in FIG. 3.

As depicted, chatbot analysis module 310 analyzes chatbot data 420, sourced from chatbot knowledge base 410, a knowledge base of an existing chatbot. The result is dataset 430, a set of topics or intents for which the chatbot is capable of answering queries as well as a set of entities, and relationships between entities, used in answering the queries.

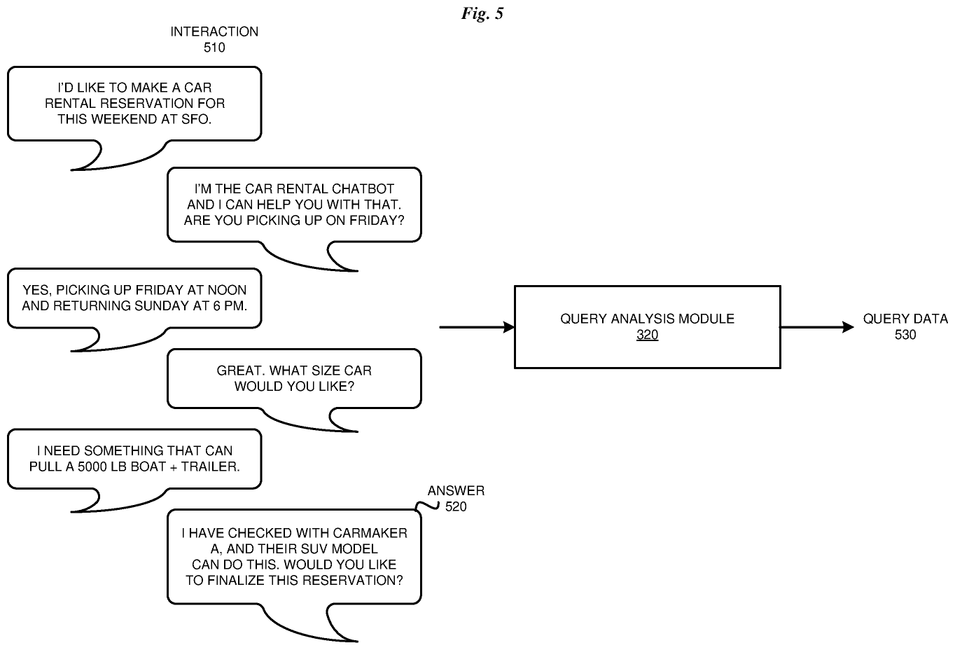

With reference to FIG. 5, this figure depicts a continued example of automated query based chatbot programming in accordance with an illustrative embodiment. The example can be executed using application 300 in FIG. 3. Query analysis module 320 is the same as query analysis module 320 in FIG. 3.

Interaction 510 depicts a chatbot interaction including answer 520, in which a chatbot used data from a data corpus external to the chatbot to provide a response to a query. Query analysis module 320 analyzes data of interaction 510 and produces query data 530, including the queries and responses within interaction 510 as well data extracted from them, including answer 520 and the source of answer 520.

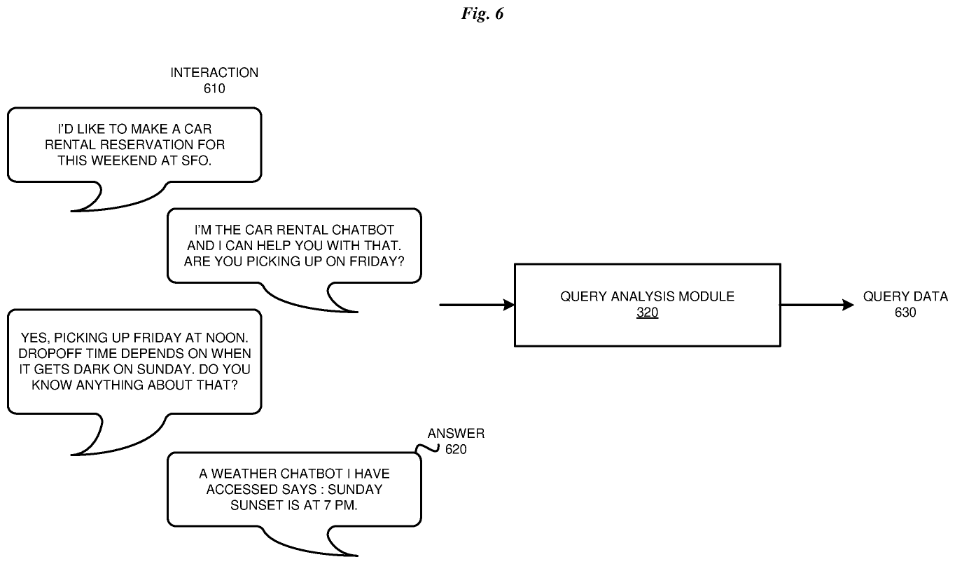

With reference to FIG. 6, this figure depicts a continued example of automated query based chatbot programming in accordance with an illustrative embodiment. The example can be executed using application 300 in FIG. 3. Query analysis module 320 is the same as query analysis module 320 in FIG. 3.

Interaction 610 depicts a chatbot interaction including answer 620, in which a chatbot used a response from a second chatbot to provide a response to a query. Query analysis module 320 analyzes data of interaction 610 and produces query data 630, including the queries and responses within interaction 610 as well data extracted from them, including answer 620 and the source of answer 620.

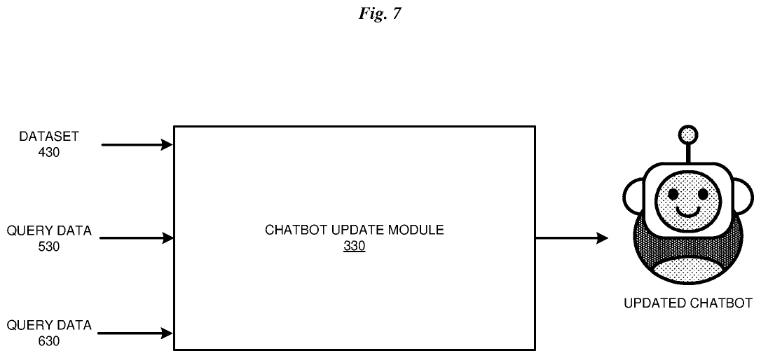

With reference to FIG. 7, this figure depicts a continued example of automated query based chatbot programming in accordance with an illustrative embodiment. The example can be executed using application 300 in FIG. 3. Chatbot update module 330 is the same as chatbot update module 330 in FIG. 3. Dataset 430 is the same as dataset 430 in FIG. 4. Query data 530 is the same as query data 530 in FIG. 5. Query data 630 is the same as query data 630 in FIG. 6.

Chatbot update module 330 uses dataset 430, query data 530, and query data 630 to generate a new chatbot or update an existing chatbot. One implementation of module 330 adds a second chatbot's answers, such as answer 520 in FIG. 5, to the first chatbot's knowledge base. Another implementation of module 330, using the queries and responses, including answer 620, in interaction 610 in FIG. 6 as training data, trains the first chatbot to answer the query.

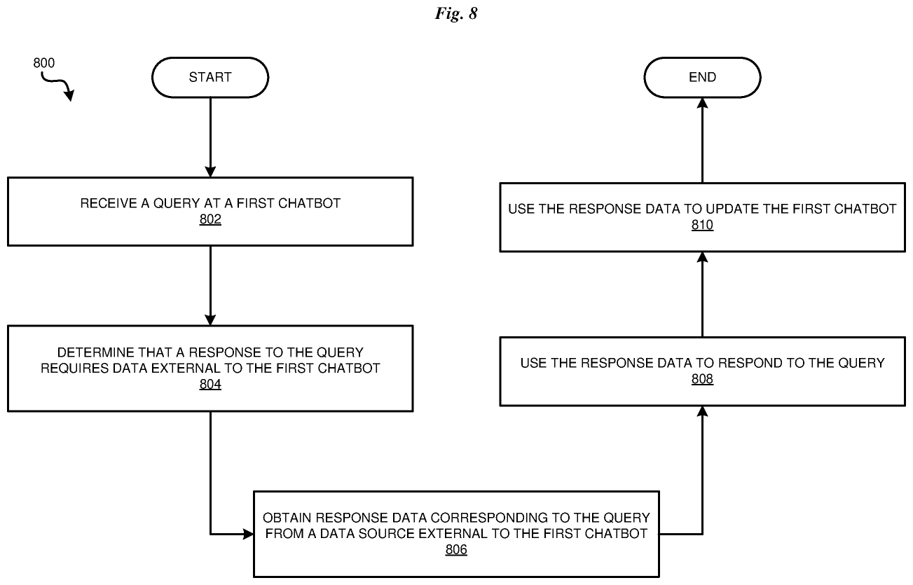

With reference to FIG. 8, this figure depicts a flowchart of an example process for automated query based chatbot programming in accordance with an illustrative embodiment. Process 800 can be implemented in application 300 in FIG. 3.

In block 802, the application receives a query at a first chatbot. In block 804, the application determines that a response to the query requires data external to the first chatbot. In block 806, the application obtains response data corresponding to the query from a data source external to the first chatbot. In block 808, the application uses the response data to respond to the query. In block 810, the application uses the response data to update the first chatbot. Then the application ends.

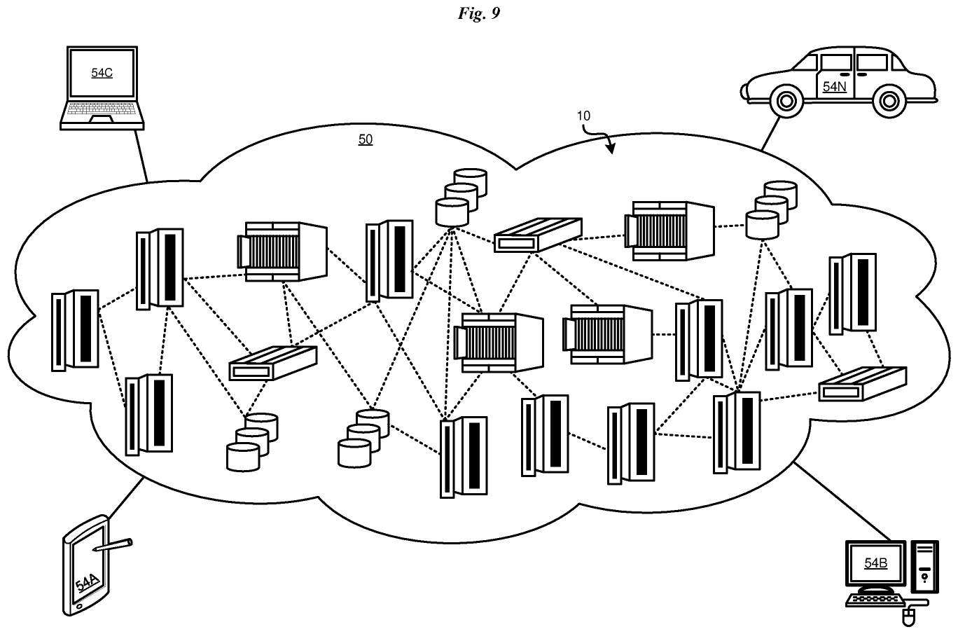

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N depicted are intended to be illustrative only and that computing nodes 10 and cloud computing environment 50 can communicate with any type of computerized device over any type of network and/or network addressable connection (e.g., using a web browser).

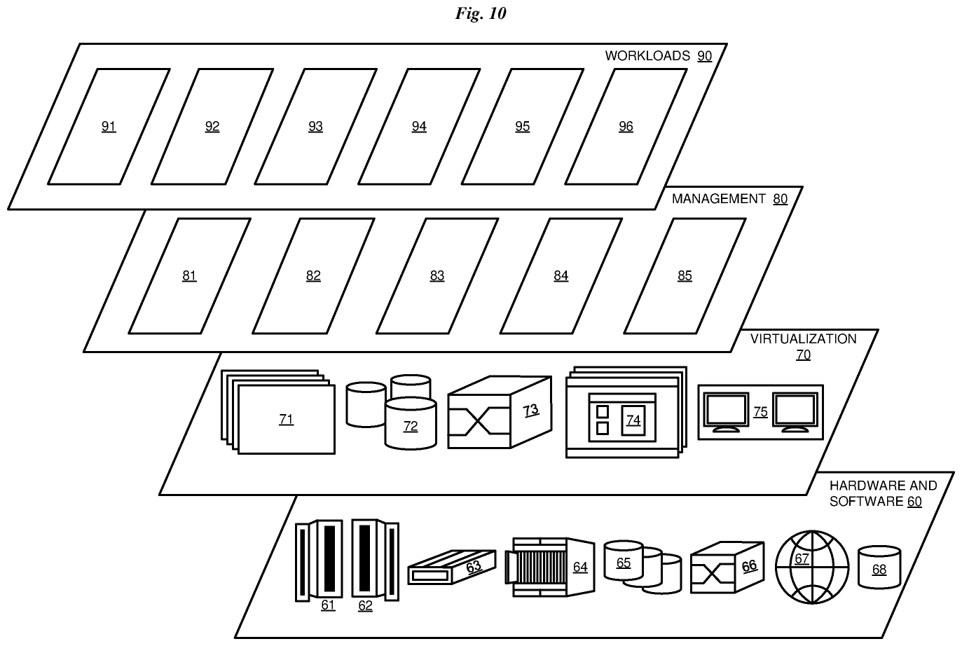

Referring now to FIG. 10, a set of functional abstraction layers provided by cloud computing environment 50 (FIG. 9) is shown. It should be understood in advance that the components, layers, and functions depicted are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and application selection based on cumulative vulnerability risk assessment 96.

Thus, a computer implemented method, system or apparatus, and computer program product are provided in the illustrative embodiments for automated query based chatbot programming and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving, at a first chatbot, a query, the query expressed in natural language form;
determining that responding to the query requires data external to the first chatbot;
obtaining, from a data source external to the first chatbot, response data corresponding to the query;
responding, using the response data, to the query, the responding resulting in a response expressed in natural language form; and
updating, using the response data, the first chatbot.

2. The computer-implemented method of claim 1, wherein obtaining, from the data source external to the first chatbot, the response data comprises:
querying, using the query, a second chatbot;
receiving, from the second chatbot, a second response expressed in natural language form; and
using, as the response data and the response, the second response.

3. The computer-implemented method of claim 1, wherein updating, using the response data, the first chatbot comprises:
adding, to a first knowledge base of the first chatbot, the response data.

4. The computer-implemented method of claim 3, wherein the adding is performed responsive to determining that the response data was previously received at least a first threshold number of times.

5. The computer-implemented method of claim 1, wherein updating, using the response data, the first chatbot comprises:
training, using the query and the response, the first chatbot to answer a subsequent query with a subsequent response, a topic of the subsequent query matching, above a threshold amount, a topic of the query, the subsequent response comprising the response data, the subsequent response expressed in natural language form.

6. The computer-implemented method of claim 5, wherein the training is performed responsive to determining that the response data was previously received at least a second threshold number of times.

7. A computer program product for automated chatbot programming, the computer program product comprising:
one or more computer readable storage media, and program instructions collectively stored on the one or more computer readable storage media, the stored program instructions comprising:
program instructions to receive, at a first chatbot, a query, the query expressed in natural language form;
program instructions to determine that responding to the query requires data external to the first chatbot;
program instructions to obtain, from a data source external to the first chatbot, response data corresponding to the query;
program instructions to respond, using the response data, to the query, the responding resulting in a response expressed in natural language form; and
program instructions to update, using the response data, the first chatbot.

8. The computer program product of claim 7, wherein program instructions to obtain, from the data source external to the first chatbot, the response data comprises:
program instructions to query, using the query, a second chatbot;
program instructions to receive, from the second chatbot, a second response expressed in natural language form; and
program instructions to use, as the response data and the response, the second response.

9. The computer program product of claim 7, wherein program instructions to update, using the response data, the first chatbot comprises:
program instructions to add, to a first knowledge base of the first chatbot, the response data.

10. The computer program product of claim 9, wherein the adding is performed responsive to determining that the response data was previously received at least a first threshold number of times.

11. The computer program product of claim 7, wherein program instructions to update, using the response data, the first chatbot comprises:
program instructions to train, using the query and the response, the first chatbot to answer a subsequent query with a subsequent response, a topic of the subsequent query matching, above a threshold amount, a topic of the query, the subsequent response comprising the response data, the subsequent response expressed in natural language form.

12. The computer program product of claim 11, wherein the training is performed responsive to determining that the response data was previously received at least a second threshold number of times.

13. The computer program product of claim 7, wherein the stored program instructions are stored in the at least one of the one or more storage media of a local data processing system, and wherein the stored program instructions are transferred over a network from a remote data processing system.

14. The computer program product of claim 7, wherein the stored program instructions are stored in the at least one of the one or more storage media of a server data processing system, and wherein the stored program instructions are downloaded over a network to a remote data processing system for use in a computer readable storage device associated with the remote data processing system.

15. The computer program product of claim 7, wherein the computer program product is provided as a service in a cloud environment.

16. A computer system comprising one or more processors, one or more computer-readable memories, and one or more computer-readable storage media, and program instructions stored on at least one of the one or more storage media for execution by at least one of the one or more processors via at least one of the one or more memories, the stored program instructions comprising:
program instructions to receive, at a first chatbot, a query, the query expressed in natural language form;
program instructions to determine that responding to the query requires data external to the first chatbot;
program instructions to obtain, from a data source external to the first chatbot, response data corresponding to the query;
program instructions to respond, using the response data, to the query, the responding resulting in a response expressed in natural language form; and
program instructions to update, using the response data, the first chatbot.

17. The computer system of claim 16, wherein program instructions to obtain, from the data source external to the first chatbot, the response data comprises:
program instructions to query, using the query, a second chatbot;
program instructions to receive, from the second chatbot, a second response expressed in natural language form; and
program instructions to use, as the response data and the response, the second response.

18. The computer system of claim 16, wherein program instructions to update, using the response data, the first chatbot comprises:
program instructions to add, to a first knowledge base of the first chatbot, the response data.

19. The computer system of claim 18, wherein the adding is performed responsive to determining that the response data was previously received at least a first threshold number of times.

20. The computer system of claim 16, wherein program instructions to update, using the response data, the first chatbot comprises:
program instructions to train, using the query and the response, the first chatbot to answer a subsequent query with a subsequent response, a topic of the subsequent query matching, above a threshold amount, a topic of the query, the subsequent response comprising the response data, the subsequent response expressed in natural language form.
